(19) United States
(12) Patent Application Publication
(10) Pub. No.: US 2008/0059364 A1
(43) Pub. Date: Mar. 6, 2008

(54) Systems and methods for performing a financial trustworthiness assessment

(76) Inventors: Lisa C. Tidwell, Houston, TX (US); Tamila Barron, League City, TX (US); Leslie Rae Michelassi, Seattle, WA (US); Bruce Dragt, Highlands Ranch, CO (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/514,681

(22) Filed: Sep. 1, 2006

(51) Int. Cl. G06Q 40/00

(52) U.S. Cl. 705/38

(57) ABSTRACT

Systems and methods are described in connection with a financial trustworthiness assessment service that provides an assessment of an individual's financial trustworthiness that is not necessarily on credit bureau information. The financial trustworthiness assessment is based, at least in part, on transaction-level financial information associated with the individual, as well as on other data associated with the individual that may be financially-based or otherwise indicative, alone or in conjunction with other data, of financial trustworthiness. For example, the assessment may be based at least in part on information from one or more repositories of information, including, but not limited to a check authorization database, a demand deposit account database, a consumer credit rating database, public data (such as bankruptcy and marriage records), department of motor vehicle records, and other third party data sources.

### FIELD OF THE INVENTION

The invention relates generally to the assessment of financial trustworthiness of individuals and, in particular, to assessments based, at least in part, on transaction-level financial data, as well as other financial data, collected about the individuals.

### BACKGROUND OF THE INVENTION

Assessments of financial trustworthiness are valuable in many business-related situations. Creditors, such as vendors of products or services, wish to avoid extending credit to individuals who are likely to default on their obligations. Accordingly, most creditors perform some form of “credit check” on a potential debtor before extending credit. Such credit checks are also performed in other situations in an attempt to investigate the individual's overall, ability to pay, or financial stability. For example, a potential landlord or employer may wish to check on an individual's financial trustworthiness before entering into a financial relationship with the individual.

Credit reports generated by conventional credit bureaus and other providers typically rely on mortgage and credit card data, as well as on publicly available records such as bankruptcy filings, liens, judgments, and the like. Many individuals, such as college students, individuals with no bank accounts, international visitors, and the like, may have only little or no credit-related history. Accordingly, standard measures may not be able to accurately assess them, or may assess them excessively negatively, although the individuals might actually be financially trustworthy.

Even for individuals who do have sufficient credit history to generate a credit rating, the credit rating is not always predictive of other financial behaviors. For example, it has been found that a person's credit rating is typically not very predictive of risk associated with accepting a check from the person.

Furthermore, while many credit information providers have access to and make use of account-level credit and payment data on the account level, such as, for example, the individual's total number of financially-related accounts, account balances, and the like, they frequently do not have access to or make use of either payment information or new purchases on a transaction-by-transaction level, including details about individual payments, remittances, cash advances, or new purchases. Thus, conventional credit ratings systems may not be responsive to very recent changes and/or developments in the subject's behavior.

At the same time, while systems exist for assessing risk associated with accepting a check, predicting, for example, whether a check proffered for payment will bounce, and, if so, whether it will ultimately be paid, such systems are not necessarily predictive of an individual's overall financial trustworthiness. For example, a person who regularly bounces checks may still be very diligent about paying their utility bills and may responsibly handle other aspects of their financial relationships.

### SUMMARY OF THE INVENTION

Embodiments of systems and methods are described in connection with a financial trustworthiness assessment (FTA) service that provides an assessment of an individual's financial trustworthiness, based, at least in part, on transaction-level financial information associated with the individual, as well as on other data associated with the individual that may be financial-based or otherwise indicative of financial trustworthiness. For example, the assessment may be based on information from one or more repositories, including, but not limited to a check authorization database, a demand deposit account database, a consumer credit rating database, public data, such as bankruptcy and marriage records, and other third party data sources.

By using data about point-of-sale transactions, remittances, and other financial relationships in which an individual participates, along with credit information and/or publicly available information about the individual, embodiments of the financial trustworthiness assessment service can provide an assessment of the individual that may be more inclusive of a broad spectrum of the individual's financial behaviors, and thus more accurate, than one based on credit information alone, especially for individuals with little or no credit history, who are commonly referred to as consumers with “thin files.”

In various preferred embodiments, the financial trustworthiness assessment service is able to access transaction-level data such as records of check, debit card, credit card, money order transactions, or transactions, and the like, which may be more readily available for the above-described individuals. Such transaction-level data may comprise information about what are known as non-cash “pay now” transactions, including, for example, check and debit transactions. For a consumer who may not otherwise have established credit relationships on which to base a financial trustworthiness assessment, data indicating that the consumer's “pay now” transactions have settled without dispute may be useful establishing the consumer's financial trustworthiness or creditworthiness.

Additionally, since stored transaction-level information is often updated more frequently, for example daily or more often, than is stored credit information, which may be updated only one or twice a month, a financial trustworthiness assessment based, at least in part, on transaction-level data can more accurately reflect very recent changes in the individual's financial behavior that may affect the individual's current financial trustworthiness.

Furthermore, a financial trustworthiness assessment that is based in part on transaction-level data can help more quickly identify and confirm potential risk based on very recent activity on the part of the individual.

Another benefit of a financial trustworthiness assessment that is based on data from a wide variety of credit and non-credit sources associated with financially-related transactions is that such an assessment may provide an enhanced ability to identify possibly fraudulent situations, such as when addresses or other key information from the various sources do not match or are not typically associated with each other.

Further benefits of embodiments of the systems and methods will be apparent to one of skill in the art upon reading the following description with reference to the figures.

Embodiments of a method of assessing a consumer's financial trustworthiness are described. The method comprises receiving a request to determine the financial trustworthiness of a consumer, in which the request is not associated with only a single check transaction. The method further comprises accessing at least a database of check transaction information, and determining financial trustworthiness of the consumer based at least in part on an analysis of the check transaction information.

Embodiments of a computer-based system for providing a financial trustworthiness assessment of an individual in response to a request are described. The system comprises a check authorization database and an assessment engine. The assessment engine is configured to receive a request for a financial trustworthiness assessment of an individual, in which the request is not associated with only a single check transaction. The assessment engine further configured to obtain data from the check authorization database and to use the data to perform a financial trustworthiness assessment of the individual.

Embodiments of a method of assessing the creditworthiness of consumer are described. The method comprises: accessing information about check transactions associated with the consumer; accessing credit bureau information associated with the consumer; and determining the consumer's creditworthiness based on the check transaction information and the credit bureau information.

Embodiments of a method of assessing a consumer's financial trustworthiness are described. The method comprises: receiving a request to determine the financial trustworthiness of a consumer in which the request is not associated with a particular demand deposit transaction; accessing at least a database of demand deposit transaction-level information associated with multiple financial entities; and determining financial trustworthiness of the consumer based at least in part on an analysis of the demand deposit transaction-level information.

For purposes of summarizing embodiments of the invention, certain aspects, advantages, and novel features of the invention have been described herein. It is to be understood that not necessarily all such aspects, advantages, or novel features will be embodied in any particular embodiment of the invention.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a block diagram that depicts one embodiment of a financial trustworthiness assessment service.

FIG. 2 depicts one embodiment of a financial trustworthiness assessment determination, showing a set of potential factors that may contribute to the assessment.

FIG. 3 depicts an embodiment of a financial trustworthiness assessment engine, showing a variety of formats in which an assessment may be reported.

FIG. 4A is a flowchart that depicts one embodiment of a process for performing a financial trustworthiness assessment.

FIG. 4B is a flowchart that depicts a more detailed view of another embodiment of the process for performing a financial trustworthiness assessment.

FIG. 5 is a flowchart that depicts one embodiment of a process for requesting a financial trustworthiness assessment.

### DETAILED DESCRIPTION OF THE INVENTION

Systems and methods are described in connection with a financial trustworthiness assessment service that provides an assessment of an individual's financial trustworthiness. The financial trustworthiness assessment is based, at least in part, on transaction-level financial information associated with the individual, as well as on other data associated with the individual that may be financially-based or otherwise indicative of financial trustworthiness.

In various preferred embodiments, the financial trustworthiness assessment service is able to access transaction-level data such as records of check, debit card, credit card, and money order transactions, or remittance transactions, which may be more readily available for individuals with little or no credit histories. This kind of transaction-level data may be available from, among other sources, a check authorization database, such as one that can is maintained for the purpose of determining the risk of accepting a given check or other promissory payment and for authorizing or declining the promissory payment. For purposes of this disclosure, a “point of sale” or “remittance” may include, but is not limited to, any of the following: a physical location at which a purchase, payment, or other financial transaction takes place; a non-physical, computer-assisted “location” at which a purchase, payment, or other transaction takes place, such as at a web site of an Internet or other network-accessible online merchant, or a non-physical, telephone-assisted “location” at which purchases, payments, and other types of financial transactions may take place over the telephone.

Furthermore, in preferred embodiments, the financial trustworthiness assessment service also uses data available from a variety of other sources in order to assess the financial trustworthiness of an individual, as will be described herein in greater detail.

By using data about point-of-sale transactions, remittances, and other financial relationships in which an individual participates, along with credit information and/or publicly available information about the individual, embodiments of the financial trustworthiness assessment service can provide an assessment of the individual that may be more inclusive of a broad spectrum of the individual's financial behaviors, and thus more accurate, than one based on credit information alone, especially for individuals with “thin” credit files.

A financial trustworthiness assessment that is based in part on transaction-level data can help more quickly identify and confirm potential risk in a situation in which, for example, an individual with a history of paying credit accounts on time begins paying the accounts late. While this behavior alone may not immediately trigger a lowered assessment of financial trustworthiness in a conventional credit-based assessment system, having the benefit of additional transaction-level data allows for a more accurate assessment of the individual's current financial trustworthiness, such as when the transaction-level data shows that the individual has also been engaging in point-of-sale transactions that signal risk—such as purchasing groceries on a credit card that has almost reached its maximum.

Further benefits of embodiments of the systems and methods will be apparent to one of skill in the art upon reading the following description with reference to the figures.

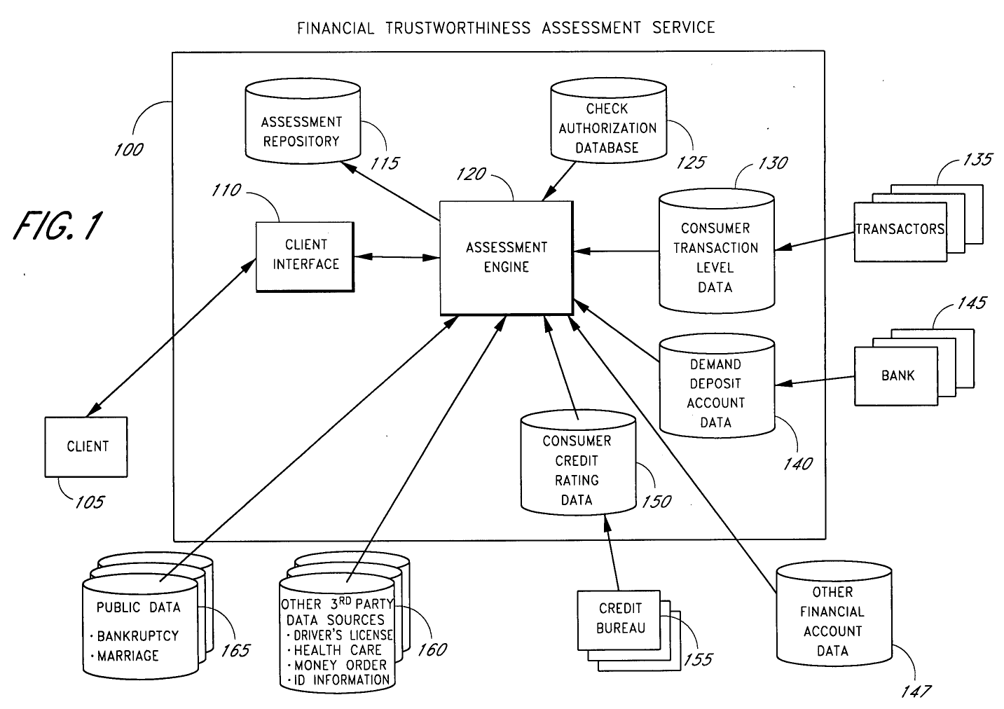

FIG. 1 is a block diagram that depicts one embodiment of a financial trustworthiness assessment service 100 that may be implemented using program logic. In one embodiment, the program logic may advantageously be implemented as one or more modules. The modules may advantageously be configured to execute on one or more processors. The modules may comprise, but are not limited to, any of the following: software or hardware modules such as software object-oriented software modules, class modules and task modules, processes methods, functions, attributes, procedures, subroutines, segments of program code, drivers, firmware, microcode, circuitry, data, databases, data structures, tables, arrays, or variables.

Furthermore, the modules may be hosted by one or more processor-based platforms, such as those implemented by Windows-based and/or UNIX-based operating platforms and may utilize one or more conventional programming languages such as DB/C, C, C++, UNIX Shell, and Structured Query Language (SQL) to accomplish methods in accordance with the invention, including system functionality, data processing, and communications between functional modules.

As depicted in FIG. 1, a client 105 communicates with a client interface 110 of the financial trustworthiness assessment service 100 to request an assessment of the financial trustworthiness of an individual, who will be referred to, for purposes of this disclosure, as the “subject” of the assessment.

The client 105 may be an individual, a business, or other entity that is interested in obtaining an assessment of the subject's financial trustworthiness. For example, the client may be a prospective landlord, employer, or other entity considering accepting a promissory payment from the individual or otherwise extending credit or financial trust to the subject.

Additionally, the client 105 may contract with the service 100 to receive multiple assessments in response to multiple assessment requests, for an agreed upon, regularly paid, fee. In other embodiments, the financial assessment service 100 may provide assessments to individuals and entities with whom the service 100 does not have a pre-established relationship, such as to clients who pay for the assessments on a request-by-request basis.

For simplicity of description, a single client 105 is depicted as communicating with the financial trustworthiness assessment service 100. However, the service 100 preferably provides financial trustworthiness assessments to many clients 105, as will be clear to one of skill in the art upon reading the disclosure herein. Thus, description of the client 105 is to be understood as pertaining to one or to a plurality of clients 105.

The client 105 may communicate with the financial trustworthiness assessment service 100 using any of a variety of communication technologies. For example, the interaction between the client 105 and a client interface 110 of the financial trustworthiness assessment service 100 takes place, in one embodiment, using a communications medium, such as the Internet, which is a global network of computers.

In other embodiments, the communications medium can be any communication system including, by way of example, dedicated communication lines, telephone networks, wireless data transmission systems, two-way cable systems, customized computer networks, interactive kiosk networks, automatic teller machine networks, interactive television networks, and the like.

In some embodiments, the client 105 may communicate using a computer terminal, including, for example, a cash register terminal, payment terminal, mobile phone, or RFID in communication with one or more peripheral devices that allow for the automatic input of data such as scanners for electronically reading driver's license, other identification card, social security number, check MICR or other identification, biometric data, and the like. In other embodiments, the client 105 may communicate using a computer terminal, such as a payment terminal, that accepts manual input of driver's license information or MICR information without using a peripheral device.

The client interface 110 provides a query interface that allows the client 105 to submit a financial trustworthiness assessment request to the service 100.

The client 105 sends to the financial trustworthiness assessment service 100 a request that provides identifying information about the subject. For example, the client 105 may provide one or more of the following types of identifying information about the subject: name, birth date, driver's license number, social security number, other identification number, address, phone number(s), employer, school, account number(s), photograph, biometric data, signature, other scanned data, and the like. In various embodiments, other types of information, such as identifying information about the client 105 may be sent to the financial trustworthiness assessment service 100 with the request.

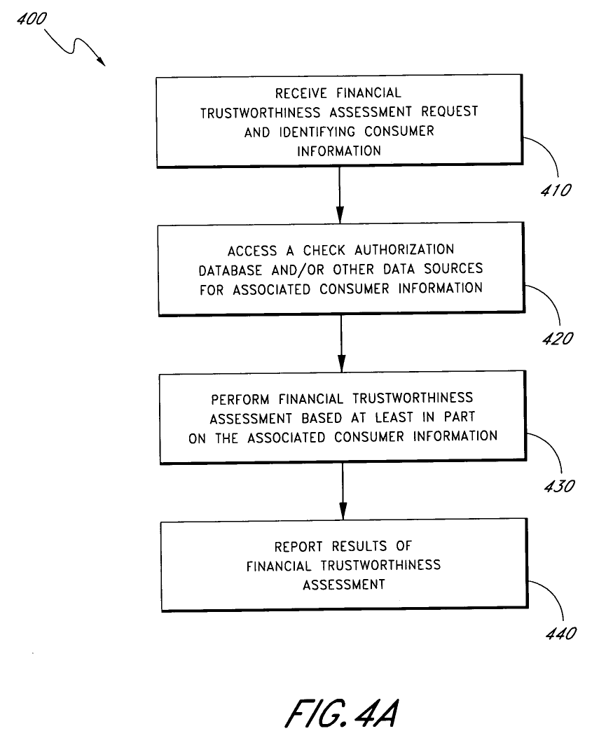

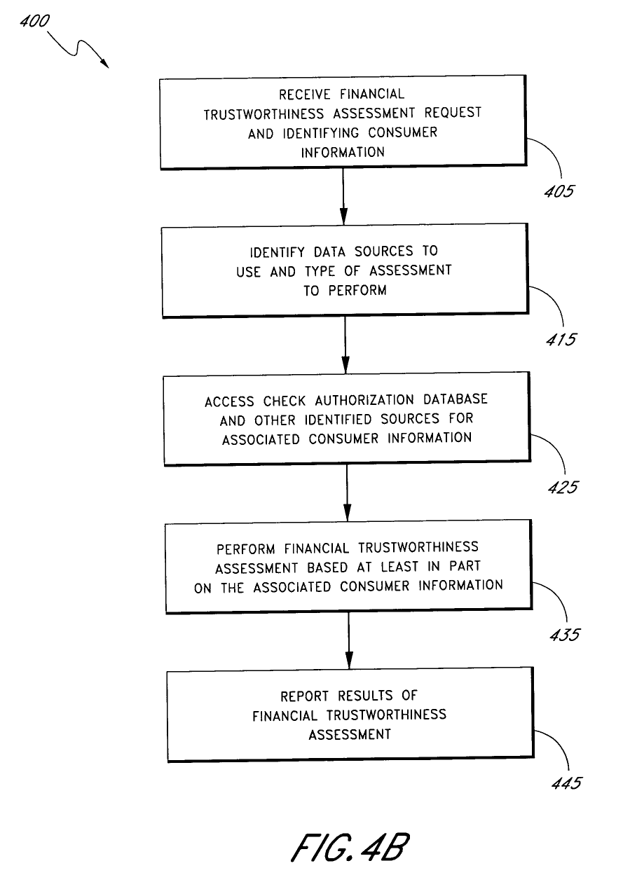

In some embodiments, the client 105 may also send additional information about the request itself. For example, in embodiments in which different types of assessments may be offered, as will be described with reference to FIG. 4B below, the client 105 may provide information about a type of assessment being requested, such as, but not limited to, a pre-employment assessment, or an assessment before authorizing a personal loan, an apartment rental, or an automobile rental. As another example, the client 105 may send information indicative of a dollar amount or other categorization associated with the request, such as a dollar amount of a loan being requested, or a level of security that may be conferred upon the subject based at least in part on the assessment.

The client interface 110 of the financial trustworthiness assessment service 100 receives the request information from the client 105 and passes the information to a financial trustworthiness assessment engine 120. The financial trustworthiness assessment engine 120 uses the identifying information together with data from a wide variety of data sources to generate an assessment of the subject's financial trustworthiness. With reference to the embodiment depicted in FIG. 1, the financial trustworthiness assessment engine 120 may use data received from one or more of the following types of data sources, which will be described in greater detail below: an assessment repository 115, a check authorization database 125, a repository of consumer transaction-level data 130, a repository of demand deposit account data 140, 147 a repository of other financial account data, a repository of consumer credit rating data 150, one or more repositories of public data 165, and one or more repositories of other third party data sources 160.

In various embodiments, the financial trustworthiness assessment engine 120 may perform the requested assessment using one or more statistical or other modeling methods, decision tree or other rule-based or classification systems, calculation scorecards, fuzzy logic systems, neural networks, or a combination of the above and/or other decision-making systems. For example, models may be built on historical financial data to predict what behaviors or combinations of factors may be indicative of financial risk.

Embodiments of the financial trustworthiness assessment engine 120 may use information about the type of assessment being requested to identify an associated scorecard or other system for weighting the various types of data to be used in the selected assessment. For example, a pre-employment financial trustworthiness assessment may assign extra weight to information received from the Department of Motor Vehicles and assign less weight to credit-related information about a potential employee. In some embodiments, types of assessment may also be categorized based on a level of expense associated with obtaining the information for the assessment and performing the assessment. In some embodiments, information a type of assessment being requested may be explicitly provided to the financial trustworthiness assessment service 100 with a given request, while in other embodiments, requests from a given client 105 may always be associated with a given type of assessment. In other embodiments, other methods of assigning an assessment method to a given assessment request may be used.

Embodiments of the financial trustworthiness assessment engine 120 may perform the assessment based, at least in part, on data sources that may be stored, entirely or in part, locally within computer processors and/or associated storage devices associated with the financial trustworthiness assessment service 100. The financial trustworthiness assessment engine 120 may, additionally or alternatively, perform the assessment based, at least in part, on data sources that may be stored externally to the financial trustworthiness assessment service 100.

The check authorization database 125 includes data about consumers who use checks and/or debit cards to make payments. For example, the check authorization database 125 may store data about consumers who pay with checks or debit cards for purchases at merchant points-of-sale, for payment of utility bills or other remittances, for purchasing money orders, and the like. The check authorization database 125 may store information about the consumers' check-writing and payment history. The information may be used as part of a check authorization system in conjunction with models or rules built to predict which checks will be returned for initial non-payment, as well as which checks will be returned and never paid, for recommending to a client whether or not to accept a proffered check or debit-card payment.

In conjunction with the financial trustworthiness assessment engine 120 depicted in FIG. 1, the data stored in the check authorization database 125 may be used for a broader assessment of the subject's financial trustworthiness in general, beyond a recommendation whether to accept or to decline a given check or debit card payment.

The financial trustworthiness assessment engine 120 in FIG. 1 also makes use of data received from the repository of consumer transaction-level data 130. The repository of consumer transaction-level data 130 may, in some embodiments, be combined with the check authorization database 125, while, in other embodiments, the two repositories 125, 130 may be stored independently.

In various embodiments, the repository of consumer transaction-level data 130 stores data about individual consumer transactions. For example, the repository of consumer transaction-level data 130 may store information about a date, a time, a place of transaction, an amount of transaction, a type of transaction, and payment history associated with the transaction, as well as other related information. In various embodiments, the repository of consumer transaction-level data 130 may include information about check and debit card transactions, as well as transactions paid using a credit card, a money order, money transfer or other payment instruments. Unlike data sources that providing information about consumer accounts at the account-level, which includes data such as current balance, average balance, number of late payments within a recent time period, and the like, the repository of consumer transaction-level data 130 includes more detailed information on how, where, and when funds from a subject's account were spent. Such detailed information allows the financial trustworthiness assessment engine 120 to perform assessments that may include a comparison of one transaction on a given day to other transactions in the same day or an analysis of transaction patterns over a time span, such as, for example, over a three-month period. For example, using data from the repository of consumer transaction-level data 130 and/or the check authorization database 125, the assessment engine 120 may identify a subject's pattern of much increased check-writing activity over the last thirty days, or, even more significant from a risk perspective, over the last sixty days or even life of the account or the subject. The assessment engine 120 may identify, not only that a subject's credit card was used six times in one day, but also the type of merchant where the card was used, and whether or not the purchases represent above-average transactions for the subject.

In preferred embodiments, the repository of consumer transaction-level data 130 is updated with data obtained from a wide variety of transactors 135, such as retailers and other merchants, utility companies and other remittance providers and/or billers, property management companies, and financial, mortgage or lending services. The transactors 135 provide frequent updates about their transactions to the financial trustworthiness assessment service 100.

In the embodiment depicted in FIG. 1, the financial trustworthiness assessment engine 120 receives information from a repository of demand deposit account (DDA) data 140 that is updated with information from one or more banks 145, credit unions, or other financial institutions that maintain demand deposit accounts for consumers. A demand deposit account is an account, such as a checking account, whose balance may be drawn upon by the owner of the account on demand, such as, without providing prior notice to the financial institution holding the account. Data stored in the repository of demand deposit account data 140 with regard to a subject's account may include identification information, such as the subject's name, social security number, driver's license number, address, or other identifying information. The repository 140 may also include identification information about the account, including account number, type of account, associated credit cards, and the like. In addition, the repository 140 may include historical information about the account, such as age of account, opening balance, average balance, number of overdraws or checks bounced, average velocity of checks or withdrawals, changes in account names, and the like.

In some embodiments of the service 100, the financial trustworthiness assessment engine 120 uses information from one or more repositories of information about other types of financial accounts. For example, data about mortgages, loans, and/or other types of financial accounts associated with the consumer may provide additional useful information for making an assessment of the consumer's financial trustworthiness.

In some embodiments of the service 100, the financial trustworthiness assessment engine 120 receives information from the repository of credit rating data 150 that may include data available from one or more credit bureaus 155, such as, but not limited to, Experian, Equifax, TransUnion, or a third-party provider of consumer credit-related data. It should be noted that while the repository of consumer credit rating data is depicted in FIG. 1 as being stored locally to the financial trustworthiness assessment service 100, as would be the case if a copy of credit-related data received from one or more of the above-identified credit bureau sources 155 were stored within the financial trustworthiness assessment service 100, other embodiments of the financial trustworthiness assessment service 100 include an assessment engine 120 that accesses the credit bureaus 155 directly for consumer credit rating data 150.

In some embodiments of the system, the financial trustworthiness assessment engine 120 stores in the assessment repository 115 results of a financial trustworthiness assessment of a subject. The financial trustworthiness assessment engine 120 may also access the stored information upon receiving a request to perform a subsequent financial trustworthiness assessment of the subject. Information about the subject and about previously performed financial trustworthiness assessments of the subject stored in the assessment repository 115 may allow the financial trustworthiness assessment engine 120 to identify and analyze changes and/or patterns in the subject's financial behaviors over time that may be indicative of a change in financial trustworthiness, such as may occur in connection with loss of a job, or a “mid-life crisis.”

Current legislation, such as federal legislation including the Fair Credit Reporting Act (FCRA) and Fair and Accurate Credit Transactions (FACT) Act provides limitations on how, where, and for what purpose certain types of consumer credit-related data may be stored and used, and may thus impose limitations on what data may be stored in the assessment repository 115 and how it may be used. For example, such legislation may impose limitations on whether information about past assessments performed at the request of different clients 105 may be stored separately per client, or mixed. Preferences of the client 105 and/or of the financial trustworthiness assessment service 100 may also affect such a determination, as provided for within the bounds of the law.

The availability of data that allows for an analysis of changes and/or patterns in the subject's financial behaviors over time may also allow the financial trustworthiness assessment engine to identify indications of stolen identity and/or other fraud when the subject's current financial activity is compared to past financial activity.

In addition to the data repositories 115, 125, 130, 140, 147, and 150 described above, which are depicted in FIG. 1 as being maintained locally to the financial trustworthiness assessment service 100, the assessment engine 120 may also obtain data for use in performing a financial trustworthiness assessment determination from one or more repositories of information that are maintained remotely from the financial trustworthiness assessment service 100. For example, the assessment engine 120 may also access one or more repositories of public data 165 and/or one or more repositories of other data from other third party data sources 160. The repositories of public data 155 may include, for example, information about marriages, divorces, real estate purchases, liens, bankruptcies, and the like. The third party information sources 160, some of which may provide access to their information by subscription or purchase, may provide additional information about the subject, such as driver's license or other identification information, healthcare-related information, information about the purchase of money orders, or any of a wide variety of other types of information made available by third party information providers.

Although with respect to FIG. 1, some of the described data repositories, namely the assessment repository 114, the check authorization database 125, the consumer transaction-level data 130, the demand deposit account data 140, and the consumer credit rating data 150, are depicted as being located internally to the financial trustworthiness assessment service 100, while the repositories of public data 165 and other third party data sources 160 are depicted as being located externally to the financial trustworthiness assessment service 100, other embodiments of financial trustworthiness assessment service 100 and its modules may be configured differently. In other embodiments, any one or more of the repositories may be centrally located and/or may be geographically dispersed. For example, one or more of the repositories may be combined and one or more of the repositories may be distributed internally and/or externally to the financial trustworthiness assessment service 100. Furthermore, in various embodiments, the financial trustworthiness assessment engine 120 makes use of only a subset of the data repositories described and/or makes use of additional data sources for providing an assessment.

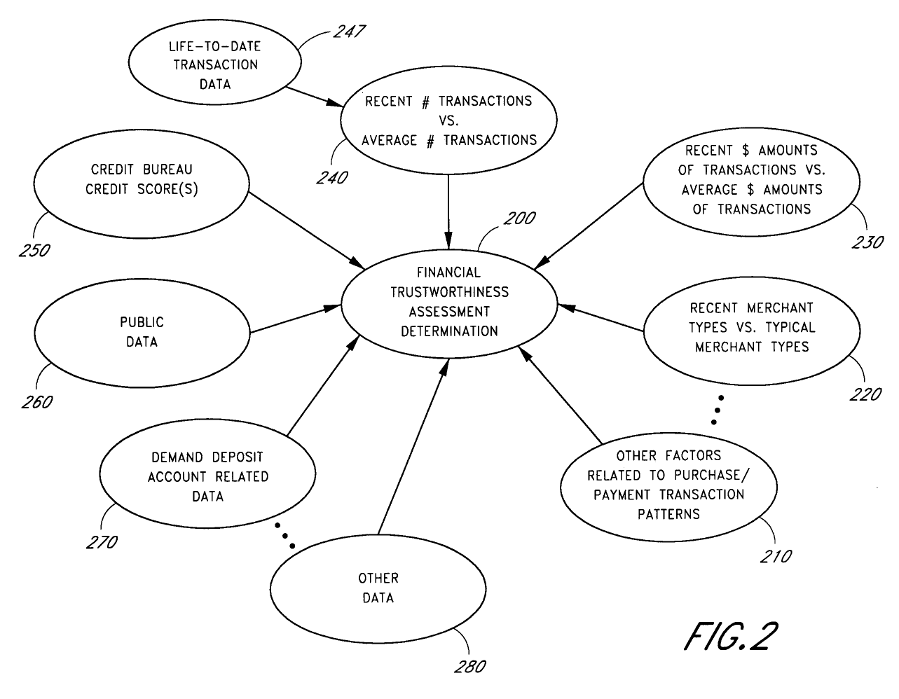

FIG. 2 depicts one embodiment of a financial trustworthiness assessment determination, showing some types of information that may be used as factors or variables for performing a financial trustworthiness assessment determination 200.

As depicted in FIG. 2, items 220, 230, 240, 247 and 210 relate to transaction-based information. For example, data about the number 240 and/or dollar amounts 230 of recent transactions, which may be compared to the individual's averages for these metrics and/or to averages in the general population or other benchmark values, may influence the determination 200. Information 210 about the type(s) of merchant(s) where recent transaction(s) have taken place may be factored in to the determination 200 because a pattern, and especially a pattern change, involving transactions with some merchant types is associated with higher level of financial risk than are transactions with other merchant types. In some embodiments, life-to-date transaction information may be used for performing a financial trustworthiness assessment determination 200. For example, data about a number of loans ever taken out by the consumer, a number of checks written, a number of debit transactions, or the like, may provide historical information indicative of the consumer's financial stability.

The above-described examples of the use of transaction-based information 210, 220, 230, 240, 247 as factors in a financial trustworthiness assessment determination 200 rely upon a comparison of the transaction data with other known data. In other embodiments of a financial trustworthiness assessment determination 200, the transaction-level data may alternatively or additionally be used in conjunction with an assessment scorecard to provide the determination 200. These and other uses of the transaction-level data will be familiar to one of skill in the art after reading the disclosure contained herein. Furthermore, as will also be familiar to one of skill in the art after reading this disclosure, in various embodiments, many other types of data may be obtained from the transaction-level data that allow for an assessment 200 of the subject's financial trustworthiness.

In addition, as was described with reference to FIG. 1, public data 260, demand deposit account-related data 270, credit bureau data 250, and other types of data 280, including financial account data, available from third-party providers may also be used as factors in the financial trustworthiness assessment determination 200.

In various embodiments of the systems and methods disclosed herein, as will be described with reference to FIG. 4B to follow, different embodiments of the financial trustworthiness assessment determination 200 may be implemented for different clients 105 or for different financial trustworthiness assessment requests made by a given client 105. For example, one client 105 may specify that assessment requests of a first sort, such as for example, for low-dollar-amount loans, be processed using a first set of factors, while assessment requests of a second sort, such as for example, for high-dollar-amount loans, be processed using a second set of factors. Differences in assessment factors used for various embodiments of the determination 200 may be based on cost differences and/or response time differences in obtaining different information and performing different types of analyses on the data.

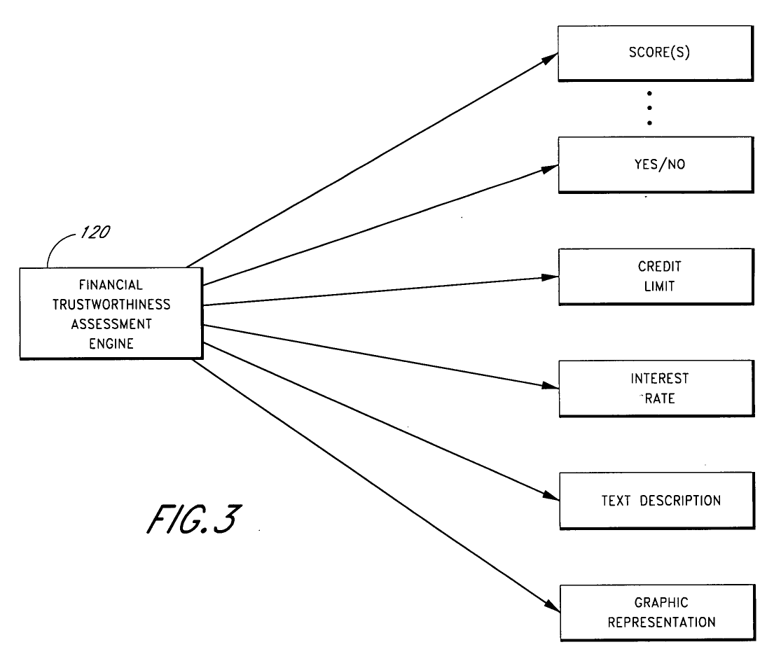

FIG. 3 depicts an embodiment of a financial trustworthiness assessment engine 120 showing a variety of data content options/formats in which an assessment may be reported to the client 105. As depicted in FIG. 3, in various embodiments, the assessment may be returned to the client 105 in the form of a numerical score or set of scores or other form of grade or other categorization, a yes/no (or accept/decline) authorization determination, a recommended or authorized credit or other dollar amount limit, a recommended or authorized interest rate, a text description, or a graphical representation. In various embodiments, the assessment may be displayed or otherwise conveyed using a terminal, an electronic cash register system, a personal computer, or other device.

FIG. 4A is a flowchart that depicts a first embodiment of a process 400 for performing a financial trustworthiness assessment. In various embodiments, the process 400 is a set of computer-executable instructions that can be implemented by the financial trustworthiness assessment engine 120 and/or by one or more other modules 110, 115, 125, 130, 140, 150 of the financial trustworthiness assessment service 100. In the embodiment depicted in FIG. 4A, the process 400 begins in block 410, in which the financial trustworthiness assessment service 100 receives a request from the client 105 to perform a financial trustworthiness assessment of the subject. In various embodiments, the client 105 provides the financial trustworthiness assessment service 100 with identifying information about the subject that allows the financial trustworthiness assessment service 100 to access relevant information about the subject from one or more sources of consumer information 115, 125, 130, 140, 150, 160, 165, as were described with reference to FIG. 1.

In block 420, the financial trustworthiness assessment service 100 accesses the check authorization database 125 that includes, among other types of information, information about DDA-related financial transactions in which the subject participated. The financial trustworthiness assessment service 100 may also access additional information about the subject from a wide variety of other sources of consumer information 115, 125, 130,140,150, 160, 165.

In block 430, the financial trustworthiness assessment engine 120 of the financial trustworthiness assessment service 100 receives the data from the check authorization database 125 and other data sources 115, 130, 140, 150, 160, 165 accessed in block 420 and uses the data to perform a financial trustworthiness assessment of the subject.

In block 440, the financial trustworthiness assessment service 100 reports the results of the assessment to the client 105. As was described with reference to FIG. 3, the results of the assessment may be presented to the client 105 and any of a variety of content formats including, but not limited to, a numerical score or set of scores or other form of grade or other categorization, a yes/no (or accept/decline) authorization determination, a recommended or authorized credit or other dollar amount limit, a recommended or authorized interest rate, a text description, or a graphical representation.

Furthermore, the results of the assessment may be transmitted to the client using any of a variety of communications media, including, but not limited to, an email message, a text message, a web page or other computer-viewable message, a telephone message or other audible message, and a postcard or letter that may be sent by way of the postal service or other delivery service.

FIG. 4B is a flowchart that depicts a more detailed view of second embodiment of the process 400 for performing a financial trustworthiness assessment in accordance with embodiments of the financial assessment service 100, in which, before making a first assessment request, the client 105 establishes a relationship with the financial assessment service 100, including agreements about financial trustworthiness assessments that the service 100 performs on behalf of the client 105.

For example, the assessment service 100 may agree to provide assessments that are customized to the preferences of the client 105. The customized assessments may draw upon data sources agreed upon by the client 105 and the financial trustworthiness assessment service 100 and/or may include assessment techniques agreed upon by the client 105 and the financial trustworthiness assessment service 100, as will be described in greater detail below. Furthermore, a given client 105 may request that different types of financial trustworthiness assessment determination methods are used for different types of requests and/or under different circumstances.

Referring now to the flowchart of FIG. 4B, in block 405 the financial trustworthiness assessment service 100 receives a request from the client 105 to perform a financial trustworthiness assessment of the subject. In various embodiments, the client 105 provides the financial trustworthiness assessment service 100 with identifying information about the subject that allows the financial trustworthiness assessment service 100 to access relevant information about the subject from one or more sources of consumer information 115, 125, 130, 140, 150, 160, 165, as were described with reference to FIG. 1. In some embodiments, the financial trustworthiness assessment request received from the client 105 may also include information about the type of assessment requested and/or the type of sources to be accessed.

In block 415, the financial trustworthiness assessment service 100 identifies the sources to use for the assessment and the type(s) of assessment to perform. In some embodiments, information used by the financial trustworthiness assessment service 100 to identify the sources and type(s) of assessment to perform are included in the request from the client 105. For example, the request may be transmitted to the financial trustworthiness assessment service 100 by way of a web page that allows the client 105 to select from amongst a set of data sources and/or from amongst a set of assessment techniques. In other embodiments, the financial trustworthiness assessment service 100 relies, in whole or in part, on stored data that provides instructions for carrying out the assessment request for the client 105.

In block 425, the financial trustworthiness assessment service 100 accesses the identified data sources, including the check authorization database 125 that includes, among other types of information, information about financial transactions in which the subject participated. The financial trustworthiness assessment service 100 may also access additional identified sources of consumer information 115, 125, 130, 140, 150, 160, 165 that are appropriate for the current assessment request.

In block 435, the financial trustworthiness assessment engine 120 performs the financial trustworthiness assessment. Examples of assessment methods that may be used by the financial trustworthiness assessment engine 120 include, but are not limited to, rule-based decisioning methods as well as various types of statistical modeling. In addition, combinations of rule-based methods and modeling methods may be used together to generate the desired financial trustworthiness assessment.

To illustrate, one example of a rule-based assessment method could include the following instruction: “Use credit bureau information if the check account is less than thirty days old and no check writing history is available.”

Embodiments of statistical modeling assessment methods may use linear regression, neural nets, and the like, to create various models for determining financial trustworthiness based on the available data about the subject.

In some embodiments, assessment methods that combine statistical modeling methods with rule-based or other decision-making methods may be used. One example of a first combination assessment method may include the following instruction: “If the potential credit amount is greater than $10,000, use Score Model ABC, else use Score Model XYZ.”

A second type of combination assessment method determines which data sources and methods to use based on an initial assessment of the subject and on costs associated with various candidate assessment methods. One example of such a cost-based combination assessment method may include the following instruction: “Use low-cost rules to categorize the subject as ‘good’ or ‘bad.’ Then, only if the subject is categorized as ‘bad,’ perform further assessment, which may be more costly, by calculating a score for the subject.”

The blocks of the embodiments of the process 400 for performing a financial trustworthiness assessment, as depicted in FIGS. 4A and 4B, may, in various other embodiments, be modified and/or re-arranged in a variety of ways, without departing from the spirit of the invention. Furthermore, a practitioner of skill in the art, after reading the disclosure herein, will be able to recognize that a wide variety of other assessment methods and combinations of assessment methods may advantageously used to provide the financial trustworthiness assessment described herein.

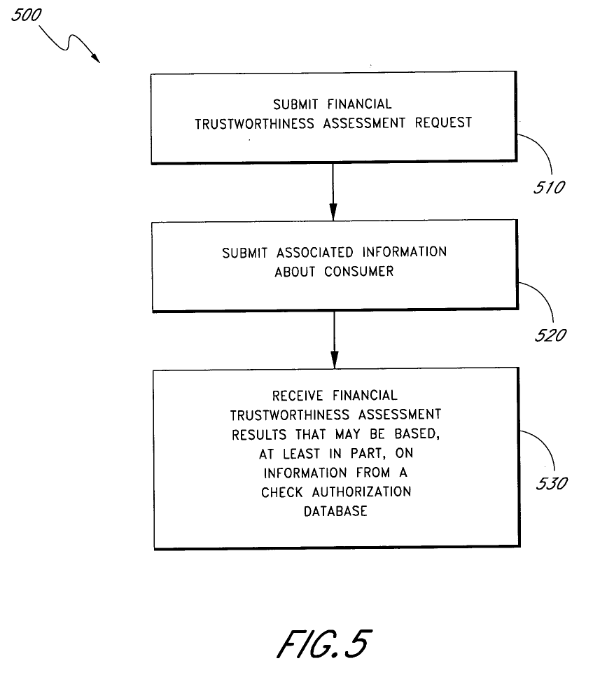

FIG. 5 is a flowchart that depicts one embodiment of a process 500 for requesting a financial trustworthiness assessment. As depicted in FIG. 5, the process begins in block 510, when a client 105 submits a financial trustworthiness assessment request. In block 520, the client 105 submits associated information about the subject of the assessment that identifies the subject and allows the financial trustworthiness assessment service 100 to access information about the subject that may be used in performing the requested assessment. In block 530, the client 105 receives financial trustworthiness assessment results about he subject that are based, at least in part on transaction-level information from the check authorization database 125.

As will be familiar to a practitioner of skill in the art, the flowcharts of FIGS. 4A, 4B, and 5 depict embodiments of the described processes 400, 500. In other embodiments, the activities described in the blocks of the processes 400, 500 may be executed in a different order than in the embodiments depicted. Furthermore, the activities described may be divided in different ways and may be performed in different combinations of steps.

While certain embodiments of the invention have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A method of assessing a consumer's financial trustworthiness, comprising:
receiving a request to determine the financial trustworthiness of a consumer, wherein the request is not associated with only a single check transaction;
accessing at least a database of check transaction information; and
determining financial trustworthiness of the consumer based at least in part on an analysis of the check transaction information.

2. The method of claim 1, further comprising:
accessing additional information from at least one of the set consisting of: demand deposit account data, consumer transaction level data, public data, consumer credit rating data, and historical information about prior financial trustworthiness assessments of the consumer; and
wherein determining the financial trustworthiness of the consumer further comprises determining the financial trustworthiness of the consumer based at least in part on the analysis of the check transaction information and on an analysis of the additional information.

3. The method of claim 1, further comprising
accessing credit bureau information associated with the consumer; and
determining the financial trustworthiness of the consumer based on the analysis of the check transaction information and on an analysis of the credit bureau information.

4. The method of claim 1, further comprising:
identifying one or more patterns associated with the consumer in the check transaction information;
wherein the analysis of the check transaction information comprises an analysis of the identified one or more patterns associated with the consumer in the check transaction information.

5. The method of claim 2, further comprising:
identifying one or more patterns associated with the consumer in the additional information; and
wherein determining the financial trustworthiness of the consumer is further based at least in part on an analysis of the identified one or more patterns associated with the consumer in the additional information.

6. The method of claim 1, further comprising
accessing additional information from at least one of the set consisting of: demand deposit account data, consumer transaction level data, public data, consumer credit rating data, and historical information about prior financial trustworthiness assessments of the consumer;
wherein receiving the request further comprises receiving information about a type of financial trustworthiness request; and
wherein determining the financial trustworthiness of the consumer further comprises weighting data from the check transaction information and from the additional information based at least in part on the information about the type of financial trustworthiness request.

7. A computer-based system for providing a financial trustworthiness assessment of an individual in response to a request, the system comprising:
a check authorization database; and
an assessment engine configured to receive a request for a financial trustworthiness assessment of an individual, wherein the request is not associated with only a single check transaction, the assessment engine further configured to obtain data from the check authorization database and to use the data to perform a financial trustworthiness assessment of the individual.

8. The system of claim 7, further comprising:
at least one additional repository of information from the set consisting of: a repository of consumer credit rating data, a repository of consumer transaction level data, and a repository of demand deposit account data; and
wherein the assessment engine is further configured to obtain data from the at least one additional repository of information, wherein the assessment engine is further configured to use the data from the at least one additional repository of information to perform the financial trustworthiness assessment of the individual.

9. The method of claim 8, wherein the assessment engine is further configured to identify one or more patterns associated with the individual in the at least one additional repository of information, to analyze the identified one or more patterns, and to use the analysis to perform the financial trustworthiness assessment of the individual.

10. The system of claim 7, wherein the assessment engine is further configured to identify one or more patterns associated with the individual in the check authorization database, to analyze the identified one or more patterns, and to use the analysis to perform the financial trustworthiness assessment of the individual.

11. The system of claim 7, wherein the assessment engine is further configured to receive information about a type of financial trustworthiness assessment being requesting and to weight data from the check transaction database based at least in part on the information about the type of financial trustworthiness assessment being requested.

12. The system of claim 7, further comprising a client interface configured to receive identifying information about the individual and to send the identifying information to the assessment engine.

13. A method of assessing the creditworthiness of consumer, the method comprising:
accessing information about check transactions associated with the consumer;
accessing credit bureau information associated with the consumer; and
determining the consumer's creditworthiness based on the check transaction information and the credit bureau information.

14. The method of claim 13, further comprising:
identifying one or more patterns associated with the consumer in the information about check transactions;
wherein determining the consumer's creditworthiness further comprises an analysis of the identified one or more patterns associated with the consumer in the information about check transactions.

15. The method of claim 13, further comprising:
identifying one or more patterns associated with the consumer in the credit bureau information;
wherein determining the consumer's creditworthiness further comprises an analysis of the identified one or more patterns associated with the consumer in the credit bureau information.

16. The method of claim 13, further comprising:
accessing additional information from at least one of the set consisting of: demand deposit account data, consumer transaction level data, public data, consumer credit rating data, and historical information about prior financial trustworthiness assessments of the consumer;
receiving a request to assess the financial creditworthiness of the consumer, wherein the request comprises receiving information about a desired type of financial creditworthiness assessment; and
wherein determining the consumer's creditworthiness further comprises weighting data from the information about check transactions, the credit bureau information, and the additional information, the weighting being based at least in part on the information about the desired type of financial creditworthiness assessment.

17. A method of assessing a consumer's financial trustworthiness, comprising:
receiving a request to determine the financial trustworthiness of a consumer wherein the request is not associated with a particular demand deposit transaction;
accessing at least a database of demand deposit transaction-level information associated with multiple financial entities; and
determining financial trustworthiness of the consumer based at least in part on an analysis of the demand deposit transaction-level information.

18. The method of claim 17, further comprising:
identifying one or more patterns associated with the consumer in the database of demand deposit transaction-level information;
wherein the analysis of the demand deposit transaction-level information comprises an analysis of the identified one or more patterns associated with the consumer in the demand deposit transaction-level information.

19. The method of claim 17, further comprising:
accessing additional information from at least one of the set consisting of: demand deposit account data, consumer transaction level data, public data, consumer credit rating data, and historical information about prior financial trustworthiness assessments of the consumer; and
identifying one or more patterns associated with the consumer in the additional information, wherein determining the financial trustworthiness of the consumer is further based at least in part on an analysis of the identified one or more patterns associated with the consumer in the additional information.

20. The method of claim 17, further comprising
accessing additional information from at least one of the set consisting of: demand deposit account data, consumer transaction level data, public data, consumer credit rating data, and historical information about prior financial trustworthiness assessments of the consumer;
wherein receiving the request to determine the financial trustworthiness of the consumer further comprises receiving information about a desired type of financial trustworthiness request; and
wherein determining the financial trustworthiness of the consumer further comprises weighting data from the demand deposit transaction-level information and from the additional information, based at least in part on the information about the type of financial trustworthiness request.
